(19) United States
(12) Patent Application Publication
(10) Pub. No.: US 2026/0176179 A1
(43) Pub. Date: Jun. 25, 2026

(54) USE OF COPPER-CYSTEAMINE FOR WASTEWATER TREATMENT

(71) Applicant: THE BOARD OF REGENTS, THE UNIVERSITY OF TEXAS SYSTEM, Austin, TX (US)

(72) Inventors: Wei CHEN, Austin, TX (US); Nilkanatha PANDEY, Austin, TX (US)

(21) Appl. No.: 18/677,890

(22) PCT Filed: Dec. 6, 2022
(86) PCT No.: PCT/US2022/051995

§ 371 Date: May 30, 2024

Related U.S. Application Data
(60) Provisional application No. 63/287,350, filed on Dec. 8, 2021.

(51) Int. Cl. C02F 3/20; C02F 3/02

(52) U.S. Cl. CPC C02F 3/207; C02F 3/02; C02F 2209/40

(57) ABSTRACT

Disclosed are compositions and methods for the treatment of wastewater.

### FIELD

Disclosed are compositions and methods for the treatment of wastewater.

### BRIEF DESCRIPTION OF THE FIGURES

FIG. 1 is the time-dependent UV-vis absorption spectra of rhodamine B (24 mg/L) in the presence of Cu-Cy nanoparticles (0.5 mg/mL) and H₂O₂ (50 mM).

FIG. 2 is the time-dependent UV-vis absorption spectra of rhodamine B in the presence of CuCl₂·2H₂O and H₂O₂.

FIG. 3 is a comparison of degradation performance of Cu-Cy with CuCl₂·2H₂O. Reaction conditions: [RhB]₀=24 mg/L, [Cu-Cy]₀=0.5 mg/mL (1.32 mM), [CuCl₂·2H₂O]₀=3.96 mM, and [H₂O₂]₀=50 mM.

FIG. 4 is time-dependent UV-vis absorption spectra of methylene blue (12 mg/L) treated with Cu-Cy (0.5 mg/mL) and H₂O₂ (50 mM).

FIG. 5 is time-dependent UV-vis absorption spectra of methylene blue treated with CuCl₂·2H₂O and H₂O₂.

FIG. 6 shows a comparison of the degradation performance of Cu-Cy with CuCl₂·2H₂O. Reaction conditions: [MB]₀=12 mg/L, [Cu-Cy]₀=0.5 mg/mL (1.32 mM), [CuCl₂·2H₂O]₀=3.96 mM, and [H₂O₂]₀=50 mM.

FIG. 7 shows representative UV-vis absorption spectra of methylene blue (MB) in the presence of H₂O₂ alone, zeolite Y+H₂O₂, Cu-Cy+H₂O₂, and commercial filter+H₂O₂. Reaction conditions: [MB]₀=12 mg/L, [H₂O₂]₀=50 mM, [zeolite Y]₀=1 mg/mL, and [Cu-Cy]₀=0.5 mg/mL.

FIG. 8 shows the effect that various microwave powers (W) have on the degradation of rhodamine B (12 mg/L) with Cu-Cy (0.5 mg/mL) and H₂O₂ (3 mM).

FIG. 9 shows the effect of various concentrations of Cu-Cy on the degradation of rhodamine B (12 mg/L) under 20 W of microwave radiation exposure with 3 mM of H₂O₂.

FIG. 10 shows the effect of various concentrations of H₂O₂ on rhodamine B degradation (12 mg/L) when subjected to 20 W of microwave radiation exposure in the presence of Cu-Cy (0.5 mg/mL).

FIG. 11 shows the effect of varying microwave power on the oxidative degradation of 4-nitrophenol (30 mg/L) in the presence of Cu-Cy (0.5 mg/mL) and H₂O₂ (10 mM).

FIG. 12 shows the effect of tert-butanol on the degradation of rhodamine B (12 mg/L) at 20 W of microwave irradiation with Cu-Cy (0.5 mg/mL) and H₂O₂ (3 mM).

FIG. 13 shows the effect of chloroform on the degradation of rhodamine B (12 mg/L) at 20 W of microwave irradiation with Cu-Cy (0.5 mg/mL) and H₂O₂ (3 mM).

FIG. 14 is an illustration of the proposed mechanism of the catalytic degradation of organic pollutants using Cu-Cy in the presence of H₂O₂ when acted upon by microwave radiation.

FIG. 15 shows the results of a recycling study using the disclosed Cu-Cy catalyst on the degradation of rhodamine B (12 mg/L) at 20 W of microwave radiation in the presence of Cu-Cy (0.5 mg/mL) and H₂O₂ (3 mM).

### DETAILED DESCRIPTION

The materials, compounds, compositions, articles, and methods described herein may be understood more readily by reference to the following detailed description of specific aspects of the disclosed subject matter and the Examples included therein.

Before the present materials, compounds, compositions, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings:

All percentages, ratios and proportions herein are by weight, unless otherwise specified. All temperatures are in degrees Celsius (° C.) unless otherwise specified.

The terms “a” and “an” are defined as one or more unless this disclosure explicitly requires otherwise.

Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Values expressed as “greater than” do not include the lower value. For example, when the “variable x” is defined as “greater than zero” expressed as “0<x” the value of x is any value, fractional or otherwise that is greater than zero.

Similarly, values expressed as “less than” do not include the upper value. For example, when the “variable x” is defined as “less than 2” expressed as “x<2” the value of x is any value, fractional or otherwise that is less than 2.

“Optional” or “optionally” means that the subsequently described event or circumstance can or cannot occur, and that the description includes instances where the event or circumstance occurs and instances where it does not.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, an apparatus that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

Any embodiment of any of the apparatuses, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Any embodiment of any of the apparatuses, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

### Compositions

Disclosed herein are compositions useful for the treatment of wastewater, comprising:
a) an effective amount of copper-cysteamine; and
b) an effective amount of hydrogen peroxide.

One aspect of the disclosed compositions, comprises:
a) from about 1 mg/mL to about 100 mg/mL of copper-cysteamine; and
b) from about 20 mM to about 80 mM hydrogen peroxide; and
c) the balance an aqueous carrier.

The disclosed composition comprises from about from about 1 mg/mL to about 100 mg/mL of copper-cysteamine. In one embodiment the disclosed composition comprises from about from about 10 mg/mL to about 90 mg/mL of copper-cysteamine. In one embodiment the disclosed composition comprises from about from about 20 mg/mL to about 80 mg/mL of copper-cysteamine. In one embodiment the disclosed composition comprises from about from about 30 mg/mL to about 70 mg/mL of copper-cysteamine. In one embodiment the disclosed composition comprises from about from about 40 mg/mL to about 60 mg/mL of copper-cysteamine. In one embodiment the disclosed composition comprises from about from about 45 mg/mL to about 60 mg/mL of copper-cysteamine.

The disclosed composition can comprise from about from about 1 mg/mL to about 100 mg/mL of copper-cysteamine, for example, 1 mg/mL, 2 mg/mL, 3 mg/mL, 4 mg/mL, 5 mg/mL, 6 mg/mL, 7 mg/mL, 8 mg/mL, 9 mg/mL, 10 mg/mL, 11 mg/mL, 12 mg/mL, 13 mg/mL, 14 mg/mL, 15 mg/mL, 16 mg/mL, 17 mg/mL, 18 mg/mL, 19 mg/mL, 20 mg/mL, 21 mg/mL, 22 mg/mL, 23 mg/mL, 24 mg/mL, 25 mg/mL, 26 mg/mL, 27 mg/mL, 28 mg/mL, 29 mg/mL, 30 mg/mL 31 mg/mL, 32 mg/mL, 33 mg/mL, 34 mg/mL, 35 mg/mL, 36 mg/mL, 37 mg/mL, 38 mg/mL, 39 mg/mL, 40 mg/mL, 41 mg/mL, 42 mg/mL, 43 mg/mL, 44 mg/mL, 45 mg/mL, 46 mg/mL, 47 mg/mL, 48 mg/mL, 49 mg/mL, 50 mg/mL, 51 mg/mL, 52 mg/mL, 53 mg/mL, 54 mg/mL, 55 mg/mL, 56 mg/mL, 57 mg/mL, 58 mg/mL, 59 mg/mL, 60 mg/mL, 61 mg/mL, 62 mg/mL, 63 mg/mL, 64 mg/mL, 65 mg/mL, 66 mg/mL, 67 mg/mL, 68 mg/mL, 69 mg/mL, 70 mg/mL, 71 mg/mL, 72 mg/mL, 73 mg/mL, 74 mg/mL, 75 mg/mL, 76 mg/mL, 77 mg/mL, 78 mg/mL, 79 mg/mL, 80 mg/mL, 81 mg/mL, 82 mg/mL, 83 mg/mL, 84 mg/mL, 85 mg/mL, 86 mg/mL, 87 mg/mL, 88 mg/mL, 89 mg/mL, 90 mg/mL, 90 mg/mL, 91 mg/mL, 92 mg/mL, 93 mg/mL, 94 mg/mL, 95 mg/mL, 96 mg/mL, 97 mg/mL, 98 mg/mL, 99 mg/mL, or 100 mg/mL.

Disclosed compositions comprise copper-cysteamine having the formula:

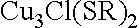

wherein R is —CH₂CH₂NH₂. The terms “copper-cysteamine,” “Cu-Cy material,” “Cu-Cy complex,” “Cu-Cy,” “disclosed material,” “disclosed complex,” “disclosed compound” and the like are used herein interchangeably throughout the present disclosure to represent the above-identified chemical compound. As disclosed in U.S. Pat. No. 9,593,131 issued Feb. 22, 2017, the compound can have various forms depending upon the method of preparation employed by the formulator. The present disclosure does not exclude any morphology, crystalline form and the like.

The disclosed Cu-Cy nanoparticles can be fabricated to various size ranges depending upon many clinical factors, for example, the type of bacteria, the size of the bacterial cluster, the concentration of the bacteria, the site of treatment, and the like.

In one aspect the nanoparticles can be extremely small in size from about 0.5 nm to about 1.00 nm, for example, 0.5 nm, 0.51 nm, 0.52 nm, 0.53 nm, 0.54 nm, 0.55 nm, 0.56 nm, 0.57 nm, 0.58 nm, 0.59 nm, 0.6 nm, 0.61 nm, 0.62 nm, 0.63 nm, 0.64 nm, 0.65 nm, 0.66 nm, 0.67 nm, 0.68 nm, 0.69 nm, 0.7 nm, 0.71 nm, 0.72 nm, 0.73 nm, 0.74 nm, 0.75 nm, 0.76 nm, 0.77 nm, 0.78 nm, 0.79 nm, 0.8 nm, 0.81 nm, 0.82 nm, 0.83 nm, 0.84 nm, 0.85 nm, 0.86 nm, 0.87 nm, 0.88 nm, 0.89 nm, 0.9 nm, 0.91 nm, 0.92 nm, 0.93 nm, 0.94 nm, 0.95 nm, 0.96 nm, 0.97 nm, 0.98 nm, 0.99 nm, or 1.00 nm.

In addition, the nanoparticles can have any size from about 1.0 nm to about 100 nm. For example, in one iteration the nanoparticles can have any size from about 10.0 nm to about 50 nm. In another iteration the nanoparticles can have any size about 50.0 nm to about 100 nm.

In a further iteration the nanoparticles can have any size about 25.0 nm to about 75.0 nm. In another aspect the nanoparticles can have a size from about 100 nm to about 200 nm, for example, 100 nm, 101 nm, 102 nm, 102 nm, 104 nm, 105 nm, 106 nm, 107 nm, 108 nm, 109 nm, 110 nm, 111 nm, 112 nm, 113 nm, 114 nm, 115 nm, 116 nm, 117 nm, 118 nm, 119 nm, 120 nm, 121 nm, 122 nm, 123 nm, 124 nm, 125 nm, 126 nm, 127 nm, 128 nm, 129 nm, 130 nm, 131 nm, 132 nm, 133 nm, 134 nm, 135 nm, 136 nm, 137 nm, 138 nm, 139 nm, 140 nm, 141 nm, 142 nm, 143 nm, 144 nm, 145 nm, 146 nm, 147 nm, 148 nm, 149 nm, 150 nm, 151 nm, 152 nm, 153 nm, 154 nm, 155 nm, 156 nm, 157 nm, 158 nm, 159 nm, 160 nm, 161 nm, 162 nm, 163 nm, 164 nm, 165 nm, 166 nm, 167 nm, 168 nm, 169 nm, 170 nm, 171 nm, 172 nm, 173 nm, 174 nm, 175 nm, 176 nm, 177 nm, 178 nm, 179 nm, 180 nm, 181 nm, 182 nm, 183 nm, 184 nm, 185 nm, 186 nm, 187 nm, 188 nm, 189 nm, 190 nm, 191 nm, 192 nm, 193 nm, 194 nm, 195 nm, 196 nm, 197 nm, 198 nm, 199 nm, or 200 nm.

In a further aspect the nanoparticles can have a size from about 200 nm to about 300 nm, for example, 200 nm, 201 nm, 202 nm, 202 nm, 204 nm, 205 nm, 206 nm, 207 nm, 208 nm, 209 nm, 210 nm, 211 nm, 212 nm, 213 nm, 214 nm, 215 nm, 216 nm, 217 nm, 218 nm, 219 nm, 220 nm, 221 nm, 222 nm, 223 nm, 224 nm, 225 nm, 226 nm, 227 nm, 228 nm, 229 nm, 230 nm, 231 nm, 232 nm, 233 nm, 234 nm, 235 nm, 236 nm, 237 nm, 238 nm, 239 nm, 240 nm, 241 nm, 242 nm, 243 nm, 244 nm, 245 nm, 246 nm, 247 nm, 248 nm, 249 nm, 250 nm, 251 nm, 252 nm, 253 nm, 254 nm, 255 nm, 256 nm, 257 nm, 258 nm, 259 nm, 260 nm, 261 nm, 262 nm, 263 nm, 264 nm, 265 nm, 266 nm, 267 nm, 268 nm, 269 nm, 270 nm, 271 nm, 272 nm, 273 nm, 274 nm, 275 nm, 276 nm, 277 nm, 278 nm, 279 nm, 280 nm, 281 nm, 282 nm, 283 nm, 284 nm, 285 nm, 286 nm, 287 nm, 288 nm, 289 nm, 290 nm, 291 nm, 292 nm, 293 nm, 294 nm, 295 nm, 296 nm, 297 nm, 298 nm, 299 nm, or 300 nm.

In a still further aspect the nanoparticles can have a size from about 300 nm to about 400 nm, for example, 300 nm, 301 nm, 302 nm, 302 nm, 304 nm, 305 nm, 306 nm, 307 nm, 308 nm, 309 nm, 310 nm, 311 nm, 312 nm, 313 nm, 314 nm, 315 nm, 316 nm, 317 nm, 318 nm, 319 nm, 320 nm, 321 nm, 322 nm, 323 nm, 324 nm, 325 nm, 326 nm, 327 nm, 328 nm, 329 nm, 330 nm, 331 nm, 332 nm, 333 nm, 334 nm, 335 nm, 336 nm, 337 nm, 338 nm, 339 nm, 340 nm, 341 nm, 342 nm, 343 nm, 344 nm, 345 nm, 346 nm, 347 nm, 348 nm, 349 nm, 350 nm, 351 nm, 352 nm, 353 nm, 354 nm, 355 nm, 356 nm, 357 nm, 358 nm, 359 nm, 360 nm, 361 nm, 362 nm, 363 nm, 364 nm, 365 nm, 366 nm, 367 nm, 368 nm, 369 nm, 370 nm, 371 nm, 372 nm, 373 nm, 374 nm, 375 nm, 376 nm, 377 nm, 378 nm, 379 nm, 380 nm, 381 nm, 382 nm, 383 nm, 384 nm, 385 nm, 386 nm, 387 nm, 388 nm, 389 nm, 390 nm, 391 nm, 392 nm, 393 nm, 394 nm, 395 nm, 396 nm, 397 nm, 398 nm, 399 nm, or 400 nm.

In a yet further aspect the nanoparticles can have a size from about 400 nm to about 500 nm, for example, 400 nm, 401 nm, 402 nm, 402 nm, 404 nm, 405 nm, 406 nm, 407 nm, 408 nm, 409 nm, 410 nm, 411 nm, 412 nm, 413 nm, 414 nm, 415 nm, 416 nm, 417 nm, 418 nm, 419 nm, 420 nm, 421 nm, 422 nm, 423 nm, 424 nm, 425 nm, 426 nm, 427 nm, 428 nm, 429 nm, 430 nm, 431 nm, 432 nm, 433 nm, 434 nm, 435 nm, 436 nm, 437 nm, 438 nm, 439 nm, 440 nm, 441 nm, 442 nm, 443 nm, 444 nm, 445 nm, 446 nm, 447 nm, 448 nm, 449 nm, 450 nm, 451 nm, 452 nm, 453 nm, 454 nm, 455 nm, 456 nm, 457 nm, 458 nm, 459 nm, 460 nm, 461 nm, 462 nm, 463 nm, 464 nm, 465 nm, 466 nm, 467 nm, 468 nm, 469 nm, 470 nm, 471 nm, 472 nm, 473 nm, 474 nm, 475 nm, 476 nm, 477 nm, 478 nm, 479 nm, 480 nm, 481 nm, 482 nm, 483 nm, 484 nm, 485 nm, 486 nm, 487 nm, 488 nm, 489 nm, 490 nm, 491 nm, 492 nm, 493 nm, 494 nm, 495 nm, 496 nm, 497 nm, 498 nm, 499 nm, or 500 nm.

### Hydrogen Peroxide

The disclosed compositions in use can comprise a continuous source of hydrogen peroxide, for example, a permanent or mobile hydrogen peroxide generator.

In one embodiment the compositions can comprise a concentration of from about 20 mM to about 80 mM hydrogen peroxide.

In another embodiment the compositions can comprise a concentration of from about 30 mM to about 70 mM hydrogen peroxide.

In a further embodiment the compositions can comprise a concentration of from about 40 mM to about 60 mM hydrogen peroxide.

In a yet further embodiment the compositions can comprise a concentration of from about 50 mM to about 70 mM hydrogen peroxide.

In a yet another embodiment the compositions can comprise a concentration of from about 30 mM to about 50 mM hydrogen peroxide.

The disclosed compositions can comprise from about 20 mM to about 80 mM hydrogen peroxide, for example, 20 mM, 21 mM, 22 mM, 23 mM, 24 mM, 25 mM, 26 mM, 27 mM, 28 mM, 29 mM, 30 mM 31 mM, 32 mM, 33 mM, 34 mM, 35 mM, 36 mM, 37 mM, 38 mM, 39 mM, 40 mM, 41 mM, 42 mM, 43 mM, 44 mM, 45 mM, 46 mM, 47 mM, 48 mM, 49 mM, 50 mM, 51 mM, 52 mM, 53 mM, 54 mM, 55 mM, 56 mM, 57 mM, 58 mM, 59 mM, 60 mM, 61 mM, 62 mM, 63 mM, 64 mM, 65 mM, 66 mM, 67 mM, 68 mM, 69 mM, 70 mM, 71 mM, 72 mM, 73 mM, 74 mM, 75 mM, 76 mM, 77 mM, 78 mM, 79 mM, or 80 mM of hydrogen peroxide.

### METHODS

Disclosed herein are methods for treating wastewater, comprising:
A) directing a wastewater stream through an apparatus containing a composition, comprising:
   a) an effective amount of copper-cysteamine; and
   b) an effective amount of hydrogen peroxide; and
B) collecting the precipitated copper-cysteamine for recycle use in the apparatus.

One aspect of the disclosed methods, comprises:
A) directing a wastewater stream through an apparatus containing a composition, comprising:
   a) from about 0.1 mg/mL to about 100 mg/mL of copper-cysteamine; and
   b) from about 20 mM to about 80 mM hydrogen peroxide; and
B) collecting any precipitated copper-cysteamine for recycle use in the apparatus.

Another aspect of the disclosed methods, comprises:
A) directing a wastewater stream through an apparatus containing a composition, comprising:
   a) from about 0.1 mg/mL to about 100 mg/mL of copper-cysteamine; and
   b) from about 20 mM to about 80 mM hydrogen peroxide; and
B) directing microwave energy into the wastewater stream.

A further aspect of the disclosed methods, comprises:
A) directing a wastewater stream through an apparatus containing a composition, comprising:
   a) from about 0.1 mg/mL to about 100 mg/mL of copper-cysteamine; and
   b) a continuous source of hydrogen peroxide; and
B) directing microwave energy into the wastewater stream.

A still further aspect of the disclosed methods, comprises:
A) directing a wastewater stream through an apparatus containing a composition, comprising:
   a) from about 0.1 mg/mL to about 100 mg/mL of copper-cysteamine; and
   b) a continuous source of hydrogen peroxide; and
B) collecting any precipitated copper-cysteamine for recycle use in the apparatus.

### Degradation Experiments

Degradation experiments demonstrating the catalytic activity of Cu-Cy to degrade rhodamine B and methylene blue were carried out as follows. To a 50 mL glass beaker, which containing 10 mL of a 24 mg/L solution of rhodamine B or a 12 mg/L solution of methylene blue dye solution and Cu-Cy nanoparticles. Before adding H₂O₂, the mixture was allowed to react at room temperature and pressure with continuous magnetic stirring in the dark for 30 min to allow the establishment of adsorption/desorption equilibrium. After that, a 50 mM solution of H₂O₂ was added, and the reaction time was noted. At regular time intervals of 3 minutes, an aliquot (1.3 mL) was withdrawn from the reaction mixture, and the sample was immediately centrifuged at 12,500 rpm for ˜25 min. The supernatant was then collected and diluted with deionized (DI) water to determine the rate of dye degradation. To monitor the progress of the degradation of the dyes, the absorption spectra were recorded using a Shimadzu spectrophotometer (UV-2450 UV-Vis), and the absorption intensities of rhodamine B and methylene blue were monitored at 553 and 663 nm, respectively. The control experiment was conducted in the presence of Cu-Cy alone and in the presence of H₂O₂ alone to determine if Cu-Cy alone or H₂O₂ alone had any influence on the degradation of the dyes. Degradation percentage was determined by using Eq. (1).

$$Degradation ( \% ) = \frac{( {A}_{0} - {A}_{t} )}{{A}_{0}} \times 100 \% \qquad ( 1 )$$

where A₀ and Aₜ are initial and final absorptions of rhodamine B (at 553 nm) or methylene blue (663 nm) after ‘t’ time, respectively. For comparison, CuCl₂·2H₂O with an equivalent concentration of copper was used under the same experimental conditions. All experiments were performed at the natural pH of the pollutants.

### Removal Performance of Cu-Cy Nanoparticles, Zeolite Y, and Commercially Available Filter on Methylene Blue

Comparisons between a commercial filter, zeolite Y, and Cu-Cy nanoparticles were used to investigate their capabilities on methylene blue removal. Briefly, the experiment was conducted in a 50 mL glass beaker that contained 10 mL mixture of methylene blue (12 mg/L), H₂O₂ (50 mM), and zeolite Y (1 mg/mL) or Cu-Cy nanoparticles (0.5 mg/mL). Afterward, the mixture was stirred under dark conditions for 5 minutes. Then, an aliquot (1.3 mL) was withdrawn, and the zeolite Y or Cu-Cy nanoparticles were removed by centrifuging at 12,500 rpm for 15 min. The supernatant was subsequently collected and diluted with DI water. Next, the diluted supernatant was analyzed by the UV-vis spectrophotometer. Likewise, 10 mL mixture of methylene blue (12 mg/L) and H₂O₂ (50 mM) was dropped into the commercially available filter. Finally, 1.3 mL of the filtered medium was centrifuged at 12,500 rpm for 15 minutes, and the supernatant was then collected and diluted with DI water to determine the rate of the dye removal.

Investigation of Catalytic Performance of Cu-Cy upon Microwave (MW) Irradiation

The catalytic degradation performance of Cu-Cy NPs under MW exposure was evaluated against rhodamine B and 4-nitrophenol. Briefly, the degradation experiment was carried out in a 50 mL measuring cylinder that contained 10 mL mixture of Cu-Cy and rhodamine B or 4-nitrophenol solution. Afterward, the mixture was stirred under dark conditions for 30 min to achieve the adsorption/desorption equilibrium. The desired amount of H₂O₂ was then added to the mixture, and MW was applied to the reaction system through a radiator probe using a microwave therapy apparatus (WB-3100AI, China). At fixed time intervals of 2 minutes, aliquots (0.9 mL) were withdrawn, and the catalysts were removed by centrifuging at 12,500 rpm for ˜25 min. Then, the supernatant was collected and diluted with DI water. Finally, the diluted supernatant was analyzed by the UV-vis spectrophotometer. Trapping experiments were conducted to determine the reactive oxygen species (ROS) produced during the catalytic degradation by adding tert-butanol (TBA) and chloroform. To demonstrate the stability and reusability of the catalyst, the used catalyst was separated by centrifugation, washed with DI water, and then used for the next cycle.

The Cu-Cy nanoparticles were prepared using the previously published protocol (see, Pandey N K et al., “A facile method for the synthesis of copper-cysteamine nanoparticles and study of ROS production for cancer treatment,” Journal of Materials Chemistry B 7(42) (2019) 6630-6642). The detailed characterizations of Cu-Cy have been described in other recent publications.

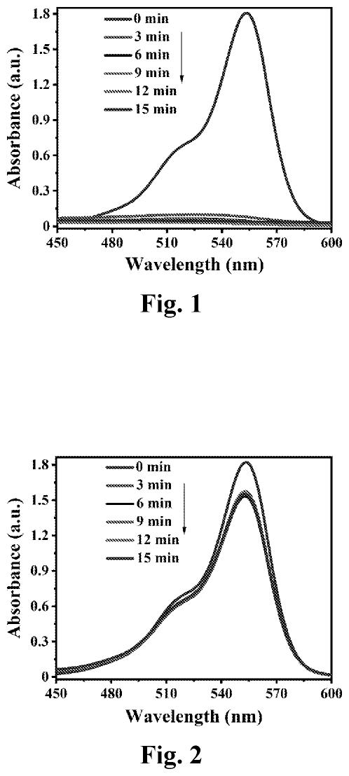

FIG. 1 shows representative UV-vis absorption spectra of rhodamine B dye (24 mg/L) as a function of reaction time from start of the experiment to 15 minutes when combined with H₂O₂ (50 mM) and Cu-Cy (0.5 mg/mL). As depicted in FIG. 1 the removal of rhodamine B proceeded almost instantaneously, with ˜₉₅% of the dye being removed within the first 6 minutes of operation. The degradation of rhodamine B was the highest during the first 3 minutes of the reaction, and then it reached a relatively stable value.

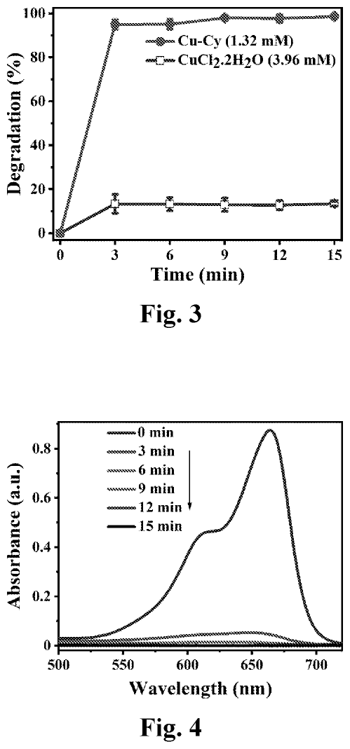

FIG. 2 shows the results of an experiment to determine if Cu²⁺ ion alone has comparable catalytic activity to Cu-Cy. A homogenous reaction system containing CuCl₂·2H₂O under the same experimental conditions as used to obtain the data depicted in FIG. 1. As depicted in FIG. 2, the degradation of rhodamine B with CuCl₂·2H₂O (3.96 mM, which is equivalent to the Cu amount in Cu-Cy) is very slow, resulting in ˜13% of degradation within 15 min of reaction. FIG. 3 depicts that Cu-Cy nanoparticles are ˜7-fold more effective in degrading rhodamine B than their raw materials CuCl₂·2H₂O.

To evaluate the versatility of Cu-Cy NPs, the catalytic behavior was also explored for the catalytic oxidation of methylene blue. FIG. 4 shows the effect of Cu-Cy (0.5 mg/mL) and H₂O₂ (50 mM) on the degradation of methylene blue (12 mg/L) over 15 minutes. As seen in FIG. 4 Cu-Cy and H₂O₂ degraded more than 98% of methylene blue within 6 minutes.

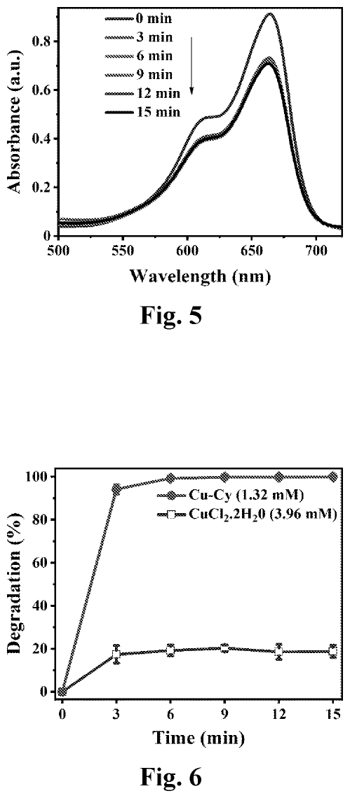

FIG. 5 shows the catalytic activity of CuCl₂·2H₂O (3.96 mM which is equivalent to the amount of Cu in Cu-Cy) on the degradation of methylene blue. As seen, methylene blue degradation is slower indicating only ˜₂₀% of degradation was seen after 15 minutes of reaction time. FIG. 6 is a plot of both experiments involving methylene blue; with Cu-Cy versus with CuCl₂·2H₂O.

As seen in Table 1, the degradation efficiencies of Cu-Cy are comparable to other heterogeneous catalysts.

TABLE 1

| | | | Operation | H₂O₂ | Catalyst | Removal |
|---|---|---|---|---|---|---|
| | | Dye Amount | Time | Amount | Amount | Efficiency |
| No. | Catalyst | (mg/L) | (min) | (mM) | (mg/mL) | (%) |
| 1. | Fe₃O₄ (S1) | 4.79 at 55° C. (RhB) | 120 | 40 | 0.5 | 97.8¹ |
| 2. | Fe₃O₄ (S1) | 3.2 at 55° C. (MB) | 120 | 40 | 0.5 | 80¹ |
| 3. | 5Cu/Al₂O₃-750 | 10 at 50° C. (RhB) | 30 | 29.4 | 1 | 98.53² |
| 4. | LaTi_{0.4}Cu_{0.6}O₃ | 8 (RhB) | 120 | 20 | 1.4 | ~94³ |
| 5. | BiFeO₃ MNPs | 4.79 (RhB) | 90 | 10 | 0.5 | 95.2⁴ |
| 6. | BiFeO₃ MNPs | 6.4 (MB) | 150^{a} | 10 | 0.5 | 79.5⁴ |
| 7. | Au/ZnO | 14.25 (MB) | 120 | 490 | 1 | 90⁵ |
| 8. | Fe₃O₄/FeMnOₓ | 23.13 (MB) | 240 | 735 | 0.5 | ~90⁶ |
| 9. | FeCeOx | 100 at 35° C. (RhB) | 150 | 80 | 1.5 | ~98⁷ |
| 10. | CuO-MeOH | 8.33 (MB) | 240 | 1633.33 | 0.17 | ~100⁸ |
| 11. | Plate-like CuO | 8.33 (MB) | 600 | 1633.33 | 0.17 | 97.2⁹ |
| 12. | Cu-Cy | 24 (RhB) | 15 | 50 | 0.5 | ~99 |
| 13. | Cu-Cy | 12 (MB) | 15 | 50 | 0.5 | ~100 |

1. F. X. Chen, et al., “Ionothermal synthesis of Fe₃O₄ magnetic nanoparticles as efficient heterogeneous Fenton-like catalysts for degradation of organic pollutants with H₂O₂,” Journal of Hazardous Materials 322 (2017) 152-162.
2. Y. Y. Sheng, et al., “Fenton-like degradation of rhodamine B over highly durable Cu-embedded alumina: Kinetics and mechanism,” Aiche Journal 64(2) (2018) 538-549.
3. L. L. Zhang, et al, “Enhanced Fenton degradation of Rhodamine B over nanoscaled Cu-doped LaTiO₃ perovskite,” Applied Catalysis B: Environmental 125 (2012) 418-424.
4. W. Luo, et al., “Efficient Removal of Organic Pollutants with Magnetic Nanoscaled BiFeO₃ as a Reusable Heterogeneous Fenton-Like Catalyst,” Environmental Science & Technology 44(5) (2010) 1786-1791.
5. L. Wolski, et al., “Formation of reactive oxygen species upon interaction of Au/ZnO with H₂O₂ and their activity in methylene blue degradation,” Catalysis Today 333 (2019) 54-62.
6. S. Xing, et al., “Characterization and reactivity of Fe₃O₄/FeMnOₓ core/shell nanoparticles for methylene blue discoloration with H₂O₂,” Applied Catalysis B: Environmental 107(3-4) (2011) 386-392.
7. N. Zhang, et al., “Critical role of oxygen vacancies in heterogeneous Fenton oxidation over ceria-based catalysts,” Journal of colloid and interface science 558 (2020) 163-172.
8. R. Srivastava, et al., “Morphologically controlled synthesis of copper oxides and their catalytic applications in the synthesis of propargylamine and oxidative degradation of methylene blue,” Colloids and Surfaces A: Physicochemical and Engineering Aspects 392(1) (2011) 271-282.
9. M. Q. Yang, et al., “Fine tuning of the morphology of copper oxide nanostructures and their application in ambient degradation of methylene blue,” Journal of Colloid and Interface Science 355(1) (2011) 15-22.

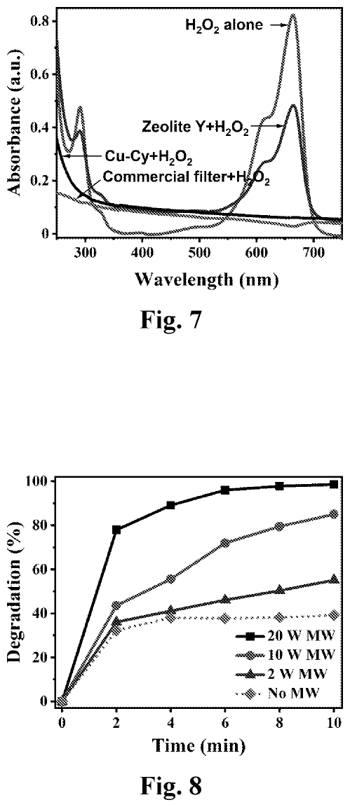

Comparisons between a commercial filter, zeolite Y, and Cu-Cy nanoparticles were also used to further investigate their performance on methylene blue removal, although it may not be fully justified to compare the degradation performance of Cu-Cy nanoparticles with commercially available filter and zeolite Y. FIG. 7 indicates that the performance of Cu-Cy nanoparticles is comparable to the commercially available filter, although further studies are needed to distinguish the difference in the byproducts. The commercial filter may adsorb the methylene blue through its activated carbon, whereas we believe that Cu-Cy nanoparticles may degrade methylene blue through a heterogeneous Fenton-like reaction. Zeolite Y was chosen due to its ability to adsorb contaminants such as ammonium and heavy metals. As depicted in FIG. 7, methylene blue removal performance of Cu-Cy nanoparticles even at 0.5 mg/mL was better than that of 1 mg/mL of zeolite Y. Our next contribution will investigate whether Cu-Cy nanoparticles produce any secondary pollutants after degrading contaminants.

FIG. 8 shows the results on the degradation of rhodamine B when the reaction solution is exposed to microwave irradiation. The power settings listed in FIG. 8 were 2 W, 10 W, and 20 W.

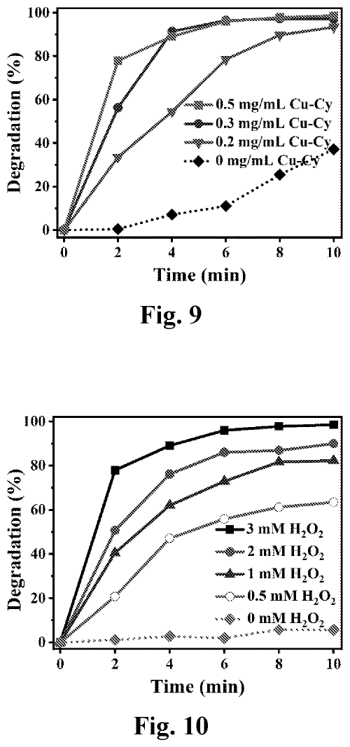

FIG. 9 shows the effect of increasing Cu-Cy concentration over the range of 0-0.5 mg/mL on the degradation of rhodamine B. Catalyst amounts of 0.3 mg/mL and 0.5 mg/mL resulted in similar performances to 0.5 mg/mL.

Similarly, FIG. 10 shows the effect of varying the hydrogen peroxide concentration upon the degradation of rhodamine B.

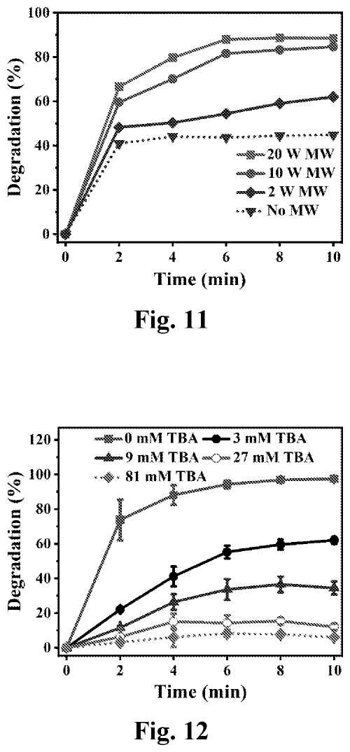

As depicted in FIG. 11, the degradation rate of 4-nitrophenol was strongly dependent on the microwave power. When FIG. 11 is viewed, these data demonstrate that the activity of Cu-Cy/H₂O₂ on the degradation of 4-nitrophenol can be increased by increasing microwave radiation power.

To evaluate whether ·OH was produced in the reaction system, we added various concentrations of tert-butanol to the reaction system. The addition of tert-butanol significantly reduced the degradation of rhodamine B as seen in FIG. 12. These data confirm the presence of ·OH. As seen in FIG. 12 a large excess of tert-butanol overloaded the catalyst which prevented efficient production of reactive oxygen species ·OH, thereby inhibiting the efficient degradation of rhodamine B.

To determine whether the reaction system could produce superoxide radical (·O₂⁻), various amounts of chloroform were added to the reaction. As depicted in FIG. 13, the degradation gradually decreased with the increase in chloroform concentration. These results indicated that the reaction system could produce ·O₂⁻.

The production of ·O₂⁻ and a significant decrease in rhodamine B degradation with the excess amount of tert-butanol indicated that most of ·O₂⁻ radicals could be generated by Eq. 2.

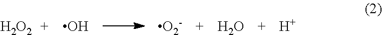

As produced ·O₂⁻ may also react with H₂O₂ to regenerate ·OH (Eq. 3) because ·O₂⁻ is the precursor of most of the ROS.

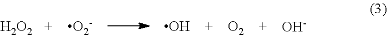

Indeed, radical reactions can be complex, involving various parallel and consecutive reactions. ROS may be generated through at least three pathways: (i) self-decomposition of H₂O₂ could occur upon microwave irradiation as presented in Eq. (4).

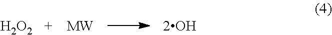

(ii) H₂O₂ decomposition could occur via heterogeneous Fenton-like process on Cu⁺ sites, and (iii) MW could efficiently accelerate the Cu²⁺/Cu⁺ redox cycles, similar to that of Fe³⁺/Fe²⁺.

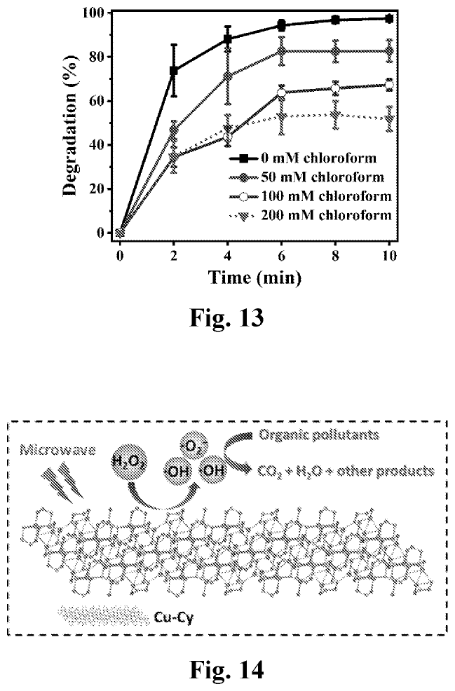

Without wishing to be limited by theory, FIG. 14 suggests a plausible catalytic mechanism of Cu-Cy for H₂O₂ activation and degradation of organic pollutants upon microwave irradiation as schematically represented.

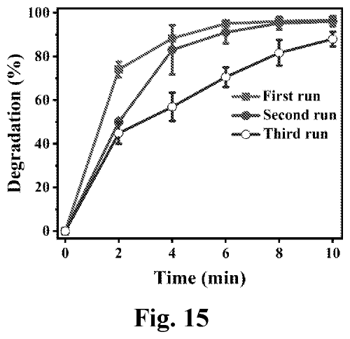

As it relates to the disclosed method of use, recycling is one of the most important parameters for the practical applicability of a catalyst. Using rhodamine B as an example to investigate the stability of Cu-Cy in wastewater scenarios, the Cu-Cy catalyst was employed for up to three cycles under the same experimental conditions. After every cycle, the catalyst was recovered by centrifugation and used for the subsequent cycle. As seen in FIG. 15, Cu-Cy has good stability and reusability. The slight decrease in degradation efficiency in the third run was due to the loss of some mass during centrifugation, as certain catalyst loss which is unavoidable during the washing process.

1. A composition for treatment of wastewater, comprising:
a) copper-cysteamine having a formula: 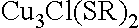
wherein R is —CH₂CH₂NH₂; and
b) hydrogen peroxide.

2. The composition according to claim 1, comprising about 1 mg/mL to about 100 mg/mL of e copper-cysteamine.

3. The composition according to claim 1, comprising about 10 mg/mL to about 90 mg/mL of the copper-cysteamine.

4. The composition according to claim 1, comprising about 20 mg/mL to about 80 mg/mL of the copper-cysteamine.

5. (canceled)

6. The composition according to claim 1, comprising f about 40 mg/mL to about 60 mg/mL of the copper-cysteamine.

7. The composition according to claim 1, wherein the particle size of the copper-cysteamine is about 0.5 nm to about 1.00 nm.

8-10. (canceled)

11. The composition according to claim 1, wherein the particle size of the copper-cysteamine is about 25 nm to about 75 nm.

12. The composition according to claim 1, comprising about 20 mM to about 80 mM of the hydrogen peroxide.

13-15. (canceled)

16. The composition according to claim 1, comprising about 30 mM to about 50 mM of the hydrogen peroxide.

17. The composition according to claim 1, wherein the hydrogen peroxide is provided by a hydrogen peroxide generator.

18. A method for treating wastewater, comprising:
A) directing a wastewater stream through an apparatus containing a composition, comprising:
a) copper-cysteamine; and
b) hydrogen peroxide; and
B) collecting precipitated copper-cysteamine and recycling the precipitated copper-cysteamine in the apparatus.

19. The method according to claim 18 wherein the composition comprises:
a) about 0.1 mg/mL to about 100 mg/mL of the copper-cysteamine; and
b) about 20 mM to about 80 mM of the hydrogen peroxide.

20. The method according to claim 18, wherein the composition comprises about 1 mg/mL to about 100 mg/mL of copper-cysteamine.

21-23. (canceled)

24. The method according to claim 18, wherein the composition comprises about 40 mg/mL to about 60 mg/mL of copper-cysteamine.

25. The method according to claim 18, wherein the particle size of the copper-cysteamine is about 0.5 nm to about 1.00 nm.

26-28. (canceled)

29. The method according to claim 18, wherein the particle size of the copper-cysteamine is about 25 nm to about 75 nm.

30. The method according to claim 18, wherein the composition comprises about 20 mM to about 80 mM of the hydrogen peroxide.

31-33. (canceled)

34. The method according to claim 18, wherein the composition comprises about 30 mM to about 50 mM of the hydrogen peroxide.

35. A method for treating wastewater, comprising:
A) directing a wastewater stream through an apparatus containing a composition, comprising:
a) about 0.1 mg/mL to about 100 mg/mL of copper-cysteamine; and
b) a continuous source of hydrogen peroxide; and
B) directing microwave energy into the wastewater stream.

36. A method for treating wastewater, comprising:
A) directing a wastewater stream through an apparatus containing a composition, comprising:
a) about 0.1 mg/mL to about 100 mg/mL of copper-cysteamine; and
b) a continuous source of hydrogen peroxide; and
B) collecting precipitated copper-cysteamine and recycling the precipitated copper-cysteamine in the apparatus.
